(19) United States
(12) Patent Application Publication
(10) Pub. No.: US 2023/0156337 A1
(43) Pub. Date: May 18, 2023

(54) ELECTRONIC DEVICE HAVING A PLURALITY OF LENSES AND CONTROLLING METHOD THEREOF

(71) Applicant: Samsung Electronics Co., Ltd., Suwon-si (KR)

(72) Inventors: Yanggeun OH, Suwon-si (KR); Sungwook YOUN, Suwon-si (KR); Byungjun SON, Suwon-si (KR); Sungjoo AHN, Suwon-si (KR); Jiyoon PARK, Suwon-si (KR)

(21) Appl. No.: 18/150,010

(22) Filed: Jan. 4, 2023

Related U.S. Application Data
(63) Continuation of application No. PCT/KR2022/016279, filed on Oct. 24, 2022.

(30) Foreign Application Priority Data
Oct. 27, 2021 (KR) 10-2021-0144893

(51) Int. Cl. H04N 23/695; H04N 5/268; H04N 23/90; H04N 23/61; H04N 23/63; H04N 7/18; H04N 23/69

(52) U.S. Cl. CPC H04N 23/695; H04N 5/268; H04N 23/90; H04N 23/61; H04N 23/635; H04N 7/181; H04N 23/69

(57) ABSTRACT

An electronic device, and method performed by the electronic device, is provided. The electronic device includes multiple cameras, a display, and at least one processor configured to execute an application supporting image capturing using the multiple cameras, obtain a first image having a first field of view via a first camera among the multiple cameras, display a preview using the first image on the display in a state where a magnification for the image capturing is configured to be a first magnification, change the preview using the first image, displayed on the display, to include at least one object identified in the first image according to a movement of the at least one object, change the magnification for the image capturing to a second magnification, based on the at least one object being positioned in a designated region of the first field of view, obtain a second image having a second field of view via a second camera among the multiple cameras, the second magnification being determined based on the first field of view, the second field of view, and a position of the at least one object in the first field of view, and display at least a part of the second image on the display as the preview, in a state in which the magnification for the image capturing is configured to be the second magnification.

### CROSS-REFERENCE TO RELATED APPLICATION(S)

This application is a continuation application, claiming priority under § 365(c), of an International application No. PCT/KR2022/016279, filed on Oct. 24, 2022, which is based on and claims the benefit of a Korean patent application number 10-2021-0144893, filed on Oct. 27, 2021, in the Korean Intellectual Property Office, the disclosure of which is incorporated by reference herein in its entirety.

### TECHNICAL FIELD

The disclosure relates to an electronic device including multiple cameras and a method performed by the electronic device.

### BACKGROUND ART

There is widespread use of electronic devices equipped with cameras, such as digital cameras, digital camcorders, or smartphones. Such electronic devices equipped with cameras incorporate functions for tracking humans, animals, things, or the like, inside images being taken by cameras and displaying tracked areas in designated sizes.

In addition, electronic devices equipped with cameras incorporate functions for detecting regions of interest, such as humans, animals, things, or the like, inside images being taken by cameras in real time and performing zoom in/out operations based on a result of the detection such that the areas of interest are displayed in designated sizes.

The above information is presented as background information only to assist with an understanding of the disclosure. No determination has been made, and no assertion is made, as to whether any of the above might be applicable as prior art with regard to the disclosure.

### DISCLOSURE

### Technical Problem

Meanwhile, a single camera may be used to track an object and to display the same on a screen, but it may be difficult, if multiple cameras are used, to naturally track the same object when cameras are switched. Screen display may become discontinuous due to a difference in the field of view and a difference in the area in which a zoom operation is applied. In addition, screen switching may become unnatural when the object is again selected manually.

In addition, although a region of interest may be detected and displayed on the screen, the limited field of view resulting from single camera use makes it challenging to frame a wider background, and excessive zoom in may degrade the image quality.

Aspects of the disclosure are to address at least the above-mentioned problems and/or disadvantages and to provide at least the advantages described below. Accordingly, an aspect of the disclosure is to provide a device and a method or the like wherein, even when cameras are switched, an identical object is continuously tracked, and auto framing is seamlessly continued.

Additional aspects will be set forth in part in the description which follows and, in part, will be apparent from the description, or may be learned by practice of the presented embodiments.

### Technical Solution

In accordance with an aspect of the disclosure, an electronic device is provided. The electronic device includes multiple cameras, a display, and at least one processor configured to execute an application supporting image capturing using the multiple cameras, obtain a first image having a first field of view via a first camera among the multiple cameras, display a preview using the first image on the display in a state where a magnification for the image capturing is configured to be a first magnification, change the preview using the first image, displayed on the display, to include at least one object identified in the first image according to a movement of the at least one object, change the magnification for the image capturing to a second magnification, based on the at least one object being positioned in a designated region of the first field of view, obtain a second image having a second field of view via a second camera among the multiple cameras, the second magnification being determined based on the first field of view, the second field of view, and a position of the at least one object in the first field of view, and display at least a part of the second image on the display as the preview, in a state in which the magnification for the image capturing is configured to be the second magnification.

In accordance with another aspect of the disclosure, an operation method of an electronic device according to an embodiment is provided. The operation method includes executing an application supporting image capturing using multiple cameras, obtaining a first image having a first field of view via a first camera among the multiple cameras, displaying a preview using the first image on a display in a state where a magnification for the image capturing is configured to be a first magnification, changing the preview using the first image, displayed on the display, to include at least one object identified in the first image according to a movement of the at least one object, changing the magnification for the image capturing to a second magnification, based on the at least one object being positioned in a designated region of the first field of view, obtaining a second image having a second field of view via a second camera among the multiple cameras, the second magnification being determined based on the first field of view, the second field of view, and a position of the at least one object in the first field of view, and displaying at least a part of the second image on the display as the preview, in a state in which the magnification for the image capturing is configured to be the second magnification.

### Advantageous Effects

According to various embodiments disclosed herein, natural camera switching makes it possible to seamlessly track an object and to continue auto framing.

According to various embodiments disclosed herein, by using multiple cameras, a user is enabled to acquire moving images with a wider angle of view and higher quality.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device according to an embodiment of the disclosure;

FIG. 2 illustrates a concept of controlling a function for performing camera switching and displaying a preview image in an electronic device according to an embodiment of the disclosure;

FIG. 3 is a flowchart of an operation of performing, by an electronic device, camera switching according to a movement of an object according to an embodiment of the disclosure;

FIG. 4 is a flowchart of an operation of performing, by an electronic device, camera switching when an object is positioned in a designated region according to an embodiment of the disclosure;

FIG. 5 is a flowchart of an operation of tracking, by an electronic device, the same object via a first camera and a second camera according to an embodiment of the disclosure;

FIG. 6A illustrates a conversion region at a first field of view when the field of view of a first camera is smaller than that of a second camera in an electronic device according to an embodiment of the disclosure;

FIG. 6B illustrates a conversion region at a first field of view when the field of view of a first camera is greater than that of a second camera in an electronic device according to an embodiment of the disclosure;

FIG. 7 is a flowchart of an operation of obtaining category information on an object tracked via a first camera in an electronic device according to an embodiment of the disclosure;

FIGS. 8A and 8B illustrate extracting zoom information according to a movement of an object when the field of view of a first camera is smaller than that of a second camera in an electronic device according to an embodiment of the disclosure;

FIGS. 9A and 9B illustrate extracting zoom information according to a movement of an object when the field of view of a first camera is greater than that of a second camera in an electronic device according to an embodiment of the disclosure;

FIG. 10 is a flowchart illustrating a case of tracking, based on category information on an object tracked by an electronic device, the same object via a second camera according to an embodiment of the disclosure;

FIG. 11A is a flowchart illustrating a case of, when an object tracked by an electronic device is a person, tracking the same object via a second camera according to an embodiment of the disclosure;

FIG. 11B is a flowchart illustrating a case of, when an object tracked by an electronic device is an animal, tracking the same object via a second camera according to an embodiment of the disclosure;

FIG. 12 is a flowchart illustrating recalculating a zoom region in an electronic device according to an embodiment of the disclosure;

FIG. 13A illustrates a second region of interest being determined when the field of view of a first camera is smaller than that of a second camera in an electronic device according to an embodiment of the disclosure;

FIG. 13B illustrates a second region of interest being determined when the field of view of a first camera is greater than that of a second camera in an electronic device according to an embodiment of the disclosure;

FIG. 14 is a block diagram of an electronic device in a network environment according to an embodiment of the disclosure; and

FIG. 15 is a block diagram showing an example of a camera module according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

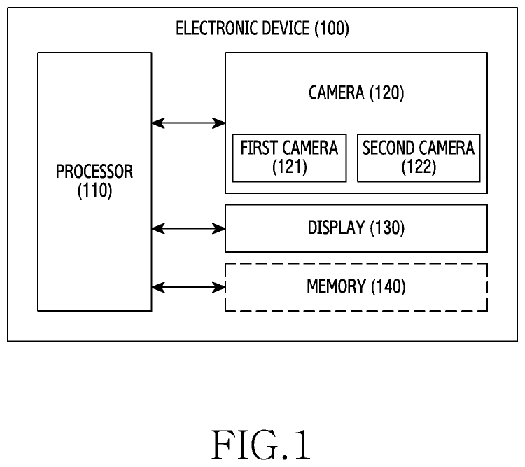

FIG. 1 is a block diagram of an electronic device according to an embodiment of the disclosure.

Referring to FIG. 1, an electronic device 100 according to an embodiment may include a processor 110, cameras 120, a display 130, and a memory 140. In various embodiments, the electronic device 100 may include additional elements other than the elements illustrated in FIG. 1, or may exclude at least one of the elements illustrated in FIG. 1.

According to an embodiment, the processor 110 may execute calculation or data processing with respect to control and/or communication of at least another element of the electronic device 100 by using instructions stored in the memory 140. According to an embodiment, the processor 110 may include at least one of a central processing unit (CPU), a graphics processing unit (GPU), a micro controller unit (MCU), a sensor hub, a supplementary processor, a communication processor, an application processor, an application specific integrated circuit (ASIC), and field programmable gate arrays (FPGA), and may have multiple cores.

According to an embodiment, the processor 110 may obtain an image via the camera 120. According to an embodiment, the processor 110 may provide an image obtained via the camera 120 on the display 130 in a preview type. According to an embodiment, the processor 110 may obtain multiple image frames by using the camera 120. According to an embodiment, the processor 110 may identify at least one object included in multiple image frames by using the camera 120, or estimate or track a movement of the object. For example, the processor 110 may identify, in a current frame, an object identical to at least one object identified in a previous frame, and track a movement of the object.

According to an embodiment, the processor 110 may switch the camera 120, based on the size of a tracked object, and/or the coordinates of the object. For example, when requirement of zoom in is determined based on the size of a tracked object, and/or the coordinates of the object, the processor 110 may switch from a camera having a large field of view to a camera having a small field of view. In addition, for example, when requirement of zoom out is determined based on the size of a tracked object, and/or the coordinates of the object, the processor 110 may switch from a camera having a small field of view to a camera having a large field of view. The switching from a camera to another camera may be directed to at least one of switching from using the camera for preview to using the other camera for the preview, switching from using the camera for image capture to the other camera for the image capture, switching from using the camera for an image processing function (e.g., tracking) to the other camera for the image processing function, switching from using the camera for an image or camera related function to the other camera for the image or camera related function, or switching from using the camera for an operation performed by the processor 110 to the other camera for the operation by processor 110.

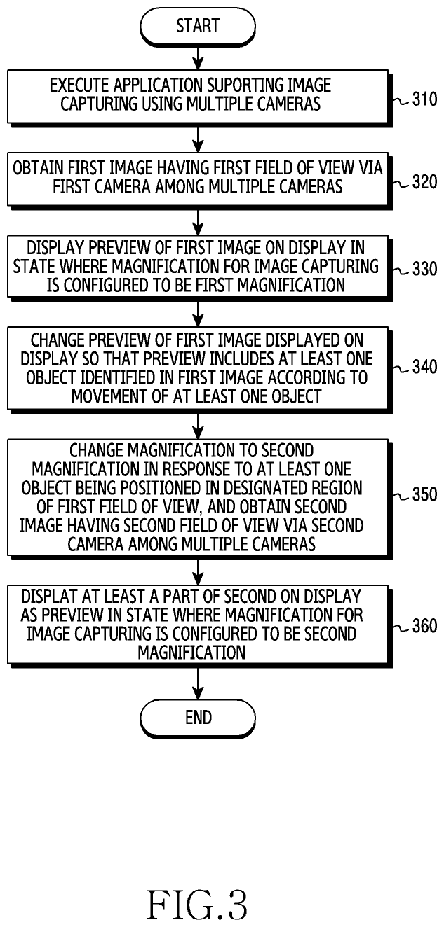

A detailed description related to an operation of the processor 110 will be given with reference to FIGS. 3 to 5, 7, 10, 11A, 11B, and 12.

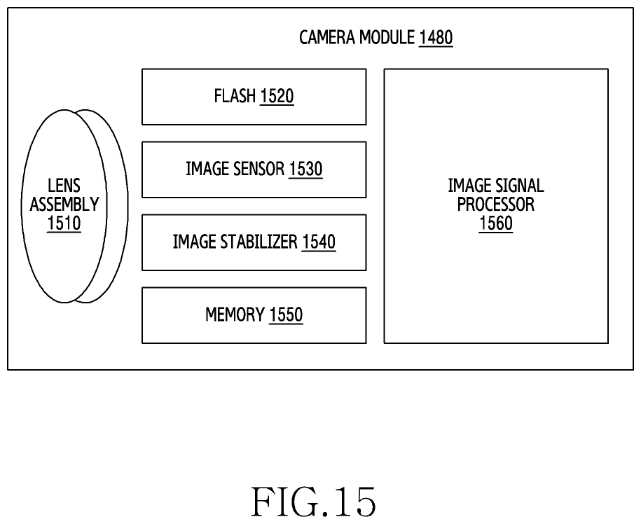

According to an embodiment, the camera 120 may acquire (or capture) an image (e.g., a still image and a moving image). For example, an image signal processor electrically connected to the camera 120 may distinguish between an object (e.g., a person, an animal, or a thing) and a background included in an image (e.g., a preview image or an image stored in the memory 140). According to an embodiment, the image signal processor may be separate from the camera 120 or may be implemented as a part of the processor 110. According to an embodiment, the camera 120 may include an image sensor (e.g., an image sensor 1530 in FIG. 15). According to an embodiment, the image sensor may obtain and/or process color information.

According to an embodiment, the camera 120 may include multiple lenses, and the multiple lenses may have different zoom levels. For example, the multiple lenses may include at least two among an ultra-wide lens, a wide lens, and a tele lens. According to an embodiment, the cameras 120 may include a first camera 121 and a second camera 122. According to an embodiment, the first camera 121 and the second camera 122 may have different lenses. For example, the first camera 121 may have a wide lens, and the second camera 122 may have an ultra-wide lens. In addition, for example, the first camera 121 may have an ultra-wide lens, and the second camera 122 may have a wide lens. In addition, for example, the first camera 121 may have a tele lens, and the second camera 122 may have a wide lens. In addition, for example, the first camera 121 may have a wide lens, and the second camera 122 may have a tele lens.

According to an embodiment, the display 130 may display a first image having a first field of view, obtained via the first camera 121 among the cameras 120. According to an embodiment, the display 130 may display a preview of the first image having the first field of view in a state where an image capturing magnification is configured to be a first magnification. According to an embodiment, the display 130 may display a second image having a second field of view, obtained via the second camera 122 among the cameras 120. According to an embodiment, the display 130 may display a preview of the second image having the second field of view in a state where an image capturing magnification is configured to be a second magnification.

According to an embodiment, the display 130 may generate a drive signal by converting an image signal, a data signal, an on-screen display (OSD) signal, and a control signal processed by the processor 110. According to an embodiment, the display 130 may be implemented as a plasma display panel (PDP), a liquid crystal display (LCD), an organic light emitting diode (OLED), and a flexible display, and may also be implemented as a three-dimensional display (3D display). According to an embodiment, the display 130 may be configured by a touch screen and thus be used as an input device as well as an output device.

According to an embodiment, the memory 140 may mean an array of one or more memories. According to an embodiment, the memory 140 may store data and/or a command received from other elements (e.g., the processor 110 and the display 130) or generated thereby.

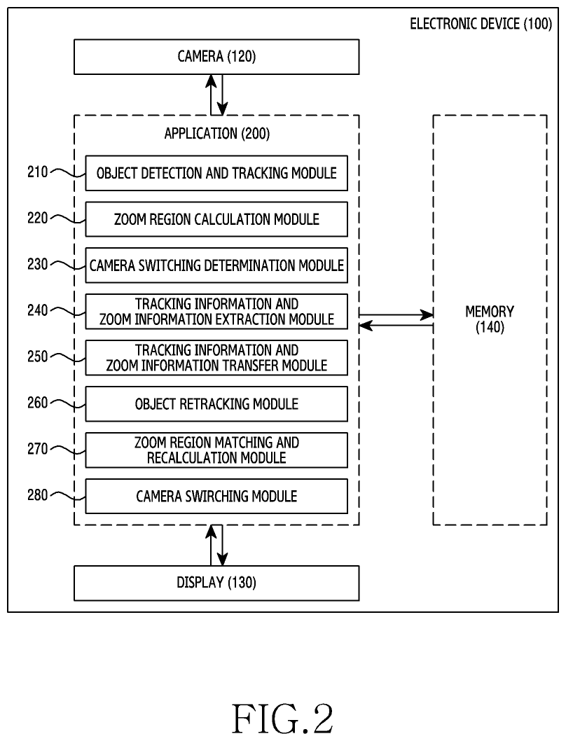

FIG. 2 illustrates a concept of controlling a function for performing camera switching and displaying a preview image in an electronic device according to an embodiment of the disclosure.

Referring to FIG. 2, an application 200 supporting image capturing using multiple cameras in the electronic device 100 according to an embodiment may include an object detection and tracking module 210, a zoom region calculation module 220, a camera switching determination module 230, a tracking information and zoom information extraction module 240, a tracking information and zoom information transfer module 250, an object retracking module 260, a zoom region matching and recalculation module 270, and a camera switching module 280. In various embodiments, the electronic device 100 may include additional elements other than the elements illustrated in FIG. 2, or may exclude at least one of the elements illustrated in FIG. 2.

According to an embodiment, the object detection and tracking module 210 may operate in an object detection mode and/or a tracking mode. According to an embodiment, the object detection and tracking module 210 may, in the object detection mode, automatically detect an object (or thing) in a preview of an image obtained via the camera 120 or manually detect an object in response to reception of a user input (e.g., a touch input) on the display 130. According to an embodiment, the object detection and tracking module 210 may track the detected object. According to an embodiment, the object detection and tracking module 210 may detect (or identify), as an object, a person's face, a part of the body or the entire body, an animal, or a thing, and there may be one or multiple objects to be tracked. According to an embodiment, the object detection and tracking module 210 may detect (or identify), as an object, a person's face, a part of the body or the entire body, an animal, or a thing in response to reception of a user input (e.g., a touch input).

According to an embodiment, the object detection and tracking module 210 may, in the tracking mode, continuously track at least one detected object, and transfer the coordinates of the at least one object to the zoom region calculation module 220. For example, when multiple objects are detected, the object detection and tracking module 210 may transfer the coordinates of each of the objects to the zoom region calculation module 220.

According to an embodiment, the zoom region calculation module 220 may calculate a region to apply zoom in or zoom out, based on the coordinates of at least one object, transferred from the object detection and tracking module 210. In this document, a zoom region may indicate a region subjected to zoom in or zoom out and then displayed on the display 130. In this document, the zoom region may be referred to as a region of interest (ROI). According to an embodiment, the zoom region may be a partial region in a preview, and as the zoom region grows greater, a zoom-out effect may occur in the display 130. According to an embodiment, as the zoom region grows smaller, a zoom-in effect may occur in the display 130.

According to an embodiment, the zoom region may be a region including the coordinates of all objects or a region including some objects. According to an embodiment, the zoom region may be the entire region of a preview or a partial region thereof. According to an embodiment, some objects may be excluded from the zoom region according to the coordinate positions of the objects in a preview. For example, when the coordinate position of an object is in a peripheral region in a preview, the object may be excluded from the zoom region. According to an embodiment, the peripheral region in the preview may be determined by a particular percentage of the entire preview area. According to an embodiment, a minimum size of the zoom region may be determined to accomplish minimum degradation of image quality. According to an embodiment, the minimum size of the zoom region may be determined by a predetermined ratio of the entire preview area.

According to an embodiment, the camera switching determination module 230 may operate according to the size, the coordinates, and the zoom region size and position of an object being tracked. According to an embodiment, a minimum zoom region size allowing the smallest degradation of image quality exists for each camera lens, and a region in a preview, in which a zoom region is movable, exists.

According to an embodiment, the camera switching determination module 230 may determine whether an object being tracked moves to a peripheral region in a preview, whether the size of the zoom region is the same as that of the preview, or whether the size of the zoom region is equal to or greater than a designated size. According to an embodiment, when an object being tracked moves to a peripheral region in a preview, when the size of the zoom region is the same as that of the preview, or when the size of the zoom region is equal to or greater than a designated size, the camera switching determination module 230 may determine that the current camera is required to be switched to a camera having a field of view wider than that of the current camera.

According to an embodiment, the camera switching determination module 230 may determine whether an object being tracked exists in a region on which a preview of the first camera and a preview of the second camera overlap with each other, whether the area of the zoom region has a minimum size, or whether the size of the zoom region is smaller than a threshold. According to an embodiment, the region on which the preview of the first camera and the preview of the second camera overlap with each other may be obtained through calibration information.

According to an embodiment, in a case where an object being tracked exists in a region on which the preview of the first camera and the preview of the second camera overlap with each other, when the area of the zoom region is determined to have a minimum size, the camera switching determination module 230 may determine that the current camera is required to be switched to a camera having a field of view narrower than that of the current camera. According to an embodiment, in a case where an object being tracked exists in a region on which the preview of the first camera and the preview of the second camera overlap with each other, when the size of the zoom region is determined to be smaller than a threshold, the camera switching determination module 230 may determine that the current camera is required to be switched to a camera having a field of view narrower than that of the current camera.

According to an embodiment, the threshold may be calculated based on a value of the field of view of the current camera. According to an embodiment, when camera switching is determined to be required, the camera switching determination module 230 may activate a switched camera. According to an embodiment, when the object coordinates and the zoom region have moved out of a designated region, the camera switching determination module 230 may deactivate a switched camera. In this document, a region on which an object is positioned and by which the camera switching determination module 230 determines to perform camera switching may be referred to as a designated region or a conversion region. In this document, a camera before switching or the current camera may be referred to as a first camera, and a camera after switching or a switched camera may be referred to as a second camera.

According to an embodiment, when the camera switching determination module 230 determines that the current camera is required to be switched to a camera having a field of view wider than that of the current camera, and then the object coordinates and the zoom region have moved out of a designated region (or a conversion region) (e.g., a peripheral region in the preview), the camera switching determination module 230 may deactivate a switched camera. As another example, when the camera switching determination module 230 determines that the current camera is required to be switched to a camera having a field of view narrower than that of the current camera, and then the object coordinates and the zoom region have moved out of a designated region (or a conversion region) (e.g., a preview center region), the camera switching determination module 230 may deactivate a switched camera.

According to an embodiment, the tracking information and zoom information extraction module 240 may operate in a tracking information extraction mode and/or a zoom information extraction mode. According to an embodiment, the tracking information and zoom information extraction module 240 may, in the tracking information extraction mode, extract tracking information after object tracking is started, and extract tracking information when the object coordinates and the zoom region exist in a conversion region and thus a switched camera is activated. According to an embodiment, the extracted tracking information may be updated. For example, the tracking information may include at least one of the size of the object, the coordinates, the texture of the object, the color of the object, and the texture of a region surrounding the object. In addition, for example, when an object being tracked is a person, the tracking information may include at least one of the hairstyle, the eyes, the nose, the mouth, the eyebrows, facial information, the texture of clothes, the texture of shoes, a saliency map, the field of view of the current camera, and calibration data. According to an embodiment, the tracking information may include tracking information on multiple objects. According to an embodiment, the tracking information may include category information on an object being tracked. For example, a category for the object being tracked may include a person, an animal, or a thing. According to an embodiment, the tracking information and zoom information extraction module 240 may, in the zoom information extraction module, at least one of camera field-of-view information, a preview size, a zoom region size, and a zoom region position in the entire preview.

According to an embodiment, the tracking information and zoom information transfer module 250 may transfer tracking information and zoom information to a switched camera. According to an embodiment, the tracking information and zoom information may be stored in the memory 140, and the switched camera may obtain the tracking information and zoom information from the memory 140. According to an embodiment, a camera before switching and a camera after switching may share the tracking information and zoom information.

According to an embodiment, the object retracking module 260 may track the same object as an object tracked via a camera before switching. According to an embodiment, the object retracking module 260 may use tracking information transferred (or obtained) to allow a switched camera to identify the same object as an object tracked via a camera before switching. According to an embodiment, the object retracking module 260 may predict the position of the same object in a preview of an image obtained via a switched camera, based on at least one of the size of a preview of an image obtained via a camera before switching, the object coordinates in the preview, the size of the object, and calibration data. According to an embodiment, multiple objects may exist in an identical object expectation region. For example, objects being tracked may include all of a person, an animal, and a thing, and in the identical object expectation region, a person, an animal, or a thing may exist. According to an embodiment, the object retracking module 260 may detect only an object included in a corresponding category, based on obtained category information. According to an embodiment, the object retracking module 260 may extract tracking information from a detected object, and compare the extracted information with received tracking information to identify an identical object. According to an embodiment, the object retracking module 260 may find the same object and then a switched camera may start object tracking.

According to an embodiment, the zoom region matching and recalculation module 270 may calculate the zoom region for soft conversion at the time of camera switching. According to an embodiment, the zoom region matching and recalculation module 270 may determine the same region as the zoom region of a camera before switching, based on the position and the size of a tracked object in a preview of an image obtained via a switched camera. For example, the zoom region matching and recalculation module 270 may calculate a zoom region, based on a ratio of the region of an object in the zoom region. According to an embodiment, a relative position and a relative size of a tracked object in a zoom region before camera switching may be identical or correspond to a relative position and a relative size of a tracked object in a zoom region after switching.

According to an embodiment, after the calculation of the zoom region, the camera switching module 280 may deactivate a camera before switching, and display, on the display 130, the zoom region in an image obtained via a camera after switching. According to an embodiment, the camera switching module 280 may perform natural switching by applying a blur effect to a region around an object at the time of switching in response to occurrence of a distortion caused by a camera field of view difference before and after switching.

FIG. 3 is a flowchart of an operation of performing, by an electronic device (e.g., the electronic device 100 in FIG. 1), camera switching according to a movement of an object according to an embodiment of the disclosure.

Referring to FIG. 3, a processor (e.g., the processor 110 in FIG. 1) according to an embodiment may, in operation 310, execute an application (e.g., the application 200 in FIG. 2) supporting image capturing using multiple cameras. For example, the application 200 supporting image capturing may include a camera application. According to an embodiment, the processor 110 may output an execution screen of the application 200 via a display (e.g., the display 130 in FIG. 1).

According to an embodiment, the processor 110 may, in operation 320, obtain a first image having a first field of view via a first camera (e.g., the first camera 121 in FIG. 1) among the multiple cameras. According to an embodiment, the processor 110 may obtain the first image having the first field of view via the first camera 121 while the application 200 supporting image capturing is executed. For example, the first camera may be one of a tele camera, a wide camera, and an ultra-wide camera.

According to an embodiment, the processor 110 may, in operation 330, display a preview of the first image on the display 130 in a state where a magnification for image capturing is configured to be a first magnification. According to an embodiment, the processor 110 may display an image received at a zoom level of the first camera 121 on a display as a preview. For example, the processor 110 may display an image received at a zoom level of a tele camera on the display 130 as a preview. In addition, for example, the processor 110 may display an image received at a zoom level of a wide camera on the display 130 as a preview. In addition, for example, the processor 110 may display an image received at a zoom level of an ultra-wide camera on the display 130 as a preview.

According to an embodiment, the processor 110 may, in operation 340, change the preview of the first image displayed on the display 130 so that the preview includes at least one object identified in the first image according to a movement of the at least one object. According to an embodiment, the processor 110 may change the preview of the first image according to a movement of an object identified in the first image so as to enable a user to identify the object via the display 130.

According to an embodiment, the processor 110 may, in operation 350, change the magnification to a second magnification in response to the at least one object being positioned in a designated region of the first field of view, and obtain a second image having a second field of view via a second camera (e.g., the second camera 122 in FIG. 1) among the multiple cameras. For example, the second magnification may indicate a random magnification distinguished from the first magnification. According to an embodiment, the processor 110 may determine whether the at least one object identified in the first image is positioned in the designated region of the first field of view.

For example, when the first field of view is smaller than the second field of view, the processor 110 may determine whether a center point of the at least one object identified in the first image is included in a region adjacent to a border of the first field of view. More specifically, for example, the processor 110 may determine whether the center point of the at least one object identified in the first image is included in a range of about 10% from the border of the first field of view. However, the designated region being a region within about 10% from the border of the first field of view merely corresponds to an example, and the designated region may be variously defined within about 10%-90% from the border of the first field of view.

As another example, when the first field of view is greater than the second field of view, the processor 110 may determine whether the center point of the at least one object identified in the first image overlaps with the second field of view or is included in a region smaller than the second field of view. In addition, for example, the processor 110 may determine whether the center point of the at least one object identified in the first image is included in a region on which a preview of the first camera and a preview of the second camera overlap with each other. More specifically, for example, the processor 110 may determine whether the center point of the at least one object identified in the first image is included in a range of about 10% from a center of the first field of view. However, the designated region being a region within about 10% from the center of the first field of view merely corresponds to an example, and the designated region may be variously defined within about 10%-90% from the center of the first field of view.

According to an embodiment, in response to that the at least one object identified in the first image is positioned in the designated region of the first field of view, the processor 110 may obtain the second image having the second field of view via the second camera 122 while the application 200 supporting image capturing is executed. For example, the first camera may be one of a tele camera, a wide camera, and an ultra-wide camera.

According to an embodiment, the processor 110 may, in operation 360, display at least a part of the second image on the display 130 as a preview in a state where the magnification for image capturing is configured to be the second magnification. According to an embodiment, the processor 110 may display an image received at a zoom level of the second camera 122 on a display as a preview. For example, the processor 110 may display an image received at a zoom level of a tele camera on the display 130 as a preview. In addition, for example, the processor 110 may display an image received at a zoom level of a wide camera on the display 130 as a preview. In addition, for example, the processor 110 may display an image received at a zoom level of an ultra-wide camera on the display 130 as a preview.

According to an embodiment, the processor 110 may change a preview displayed on the display 130 from the first image to at least partial region of the second image. According to an embodiment, the processor 110 may change a preview displayed on the display 130 to at least partial region of the second image obtained via the second camera according to gradual change in the magnification from the first magnification to the second magnification in a state where the first image obtained via the first camera is displayed.

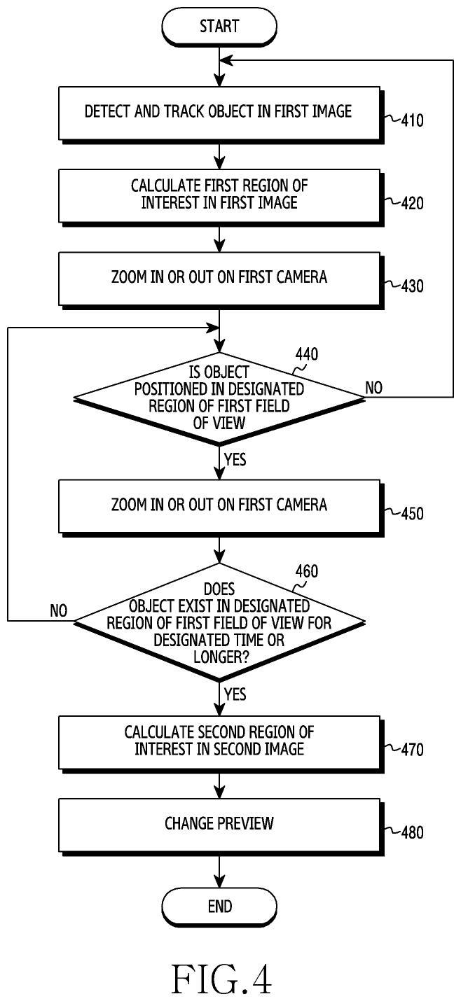

FIG. 4 is a flowchart of an operation of performing, by an electronic device, camera switching when an object is positioned in a designated region. A description for FIG. 4 overlapping with or corresponding to the above description will be briefly given or omitted according to an embodiment of the disclosure.

Referring to FIG. 4, the processor 110 according to an embodiment may, in operation 410, detect and track an object in a first image. According to an embodiment, the processor 110 may automatically detect a person's head, a part of the body or the entire body, an animal, or a thing in a preview of the first image. According to an embodiment, the processor 110 may detect an object to be tracked in the first image in response to reception of a user input (e.g., touch input) on the display 130, while the preview of the first image is displayed on the display 130. For example, one or multiple objects may be detected.

According to an embodiment, the processor 110 may, in operation 420, calculate a first region of interest in the first image. According to an embodiment, the processor 110 may calculate the first region of interest, based on the coordinates of the object detected in the first image. According to an embodiment, the processor 110 may calculate the first region of interest to include the entirety or only a part of the object. According to an embodiment, the processor 110 may calculate the first region of interest to be the entirety or a partial region of the preview.

According to an embodiment, the processor 110 may, in operation 430, zoom in or out by using the first camera 121. According to an embodiment, the processor 110 may determine the size of the first region of interest, based on the size of the detected object. According to an embodiment, the processor 110 may perform a zoom-in or zoom-out operation by using the first camera according to the size of the first region of interest. For example, when the size of the first region of interest becomes small, the processor 110 may perform a zoom-in operation by using the first camera 121. As another example, when the size of a zoom region becomes large, the processor 110 may perform a zoom-out operation by using the first camera 121. A minimum size of the first region of interest may be a size allowing minimum degradation of image quality, and a criterion of deterioration of image quality may be defined by a user.

According to an embodiment, the processor 110 may, in operation 440, determine whether the object is positioned in a designated region of a first field of view. According to an embodiment, the processor 110 may track the detected object. According to an embodiment, the processor 110 may determine an object region corresponding to the detected object, and track the object region. For example, the object region may include a margin region larger than the detected object. The processor 110 may include the margin region in the object region, and thus when there is a movement such as slight shaking of the object, disregard the movement to prevent shaking of the preview image.

According to an embodiment, whether the tracked object moves to a designated region (or a conversion region) of the first field of view may be determined. For example, one or multiple tracked objects may exist. For example, the designated region of a case when the first field of view is smaller than a second field of view may indicate a region adjacent to a border of the first field of view. As another example, the designated region of a case when the first field of view is greater than the second field of view may indicate a region on which a preview of the first camera and a preview of a second camera overlap with each other.

According to an embodiment, the processor 110 may determine the designated region, based on a movement speed of the tracked object. For example, as the movement speed of the tracked object grows greater, the processor 110 may determine the designated region to have a large size. In addition, for example, as the movement speed of the tracked object grows smaller, the processor 110 may determine the designated region to have a small size. However, the disclosure is not limited thereto, and the processor 110 may determine various sizes of the designated regions.

According to an embodiment, the processor 110 may, in operation 450, zoom in or out by using the first camera 121 when the object is determined to be positioned in the designated region of the first field of view. According to an embodiment, when it is determined that the tracked object has moved to the designated region of the first field of view, the processor 110 may adjust the size of the first field of view for soft conversion at the time of camera switching so as to provide a zoom-in or zoom-out effect via the display 130. For example, when the first field of view is greater than the second field of view, the processor 110 may provide a zoom-in effect by reducing the size of the first region of interest. As another example, when the first field of view is greater than the second field of view, the processor 110 may provide a zoom-out effect by increasing the size of the first region of interest.

According to the above embodiment, the processor 110 may perform a zoom-in or zoom-out operation before switching the camera to the second camera, thereby providing an effect of soft conversion at the time of switching to the second camera.

According to an embodiment, when the object is determined not to be in the designated region of the first field of view, the processor 110 may return to operation 410.

According to an embodiment, the processor 110 may, in operation 460, determine whether the object exists in the designated region of the first field of view for a designated time or longer.

According to an embodiment, when the object is determined to exist in the designated region of the first field of view for the designated time or longer, the processor 110 may, in operation 470, calculate a second region of interest in a second image. For example, the second region of interest may indicate a region including the same object as the object tracked via the first camera 121. According to an embodiment, when a time for which the tracked object is included in the designated region of the first field of view is equal to or greater than a threshold, the processor 110 may calculate the second region of interest in the second image. According to an embodiment, the processor 110 may determine the second region of interest, based on the position of the object in the first region of interest or a ratio of the size of the object to the first region of interest. For example, the position of the object in the first region of interest and a ratio of the size of the object to the first region of interest may correspond to the position of the object in the second region of interest and a ratio of the size of the object to the second region of interest, respectively.

According to an embodiment, when the object is determined not to exist in the designated region of the first field of view for the designated time or longer, the processor 110 may return to operation 440. For example, in a case where the object is out of the designated region when a time smaller than the threshold has passed after the object moves to the designated region of the first field of view, the processor 110 may return to operation 440.

According to an embodiment, the processor 110 may, in operation 480, change the preview displayed on the display 130. According to an embodiment, the processor 110 may display a preview image based on the second region of interest on the display 130 when the second region of interest is determined.

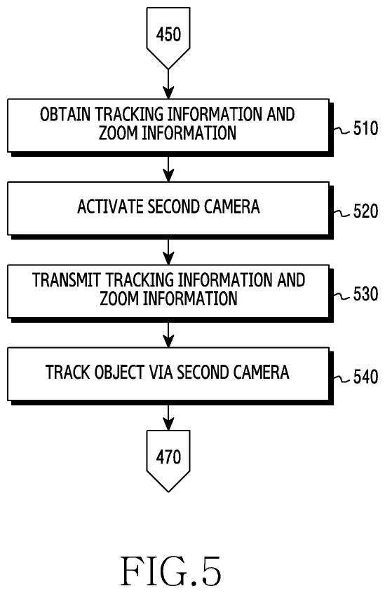

FIG. 5 is a flowchart of an operation of tracking, by an electronic device, the same object via a first camera and a second camera. Operation 510 to operation 540 shown in FIG. 5 may be performed together with operation 460 shown in FIG. 4 according to an embodiment of the disclosure.

Referring to FIG. 5, in operation 450 of FIG. 4, the processor 110 may zoom in or zoom out using the first camera, and then, in operation 510, may obtain tracking information and zoom information. According to an embodiment, the processor 110 may extract (or obtain) tracking information and zoom information to be transferred to the second camera. According to an embodiment, the processor 110 may extract different tracking information according to the category of the tracked object. For example, when the category of the tracked object is a person, the processor 110 may extract at least one of facial information (e.g., a facial outer line, the eyes, the nose, the mouth, and the eyebrows), hair color, hail line, hairstyle, presence/absence of glasses, clothing (e.g., top and bottom) color, clothing pattern texture, and shoe texture. In addition, for example, when the category of the tracked object is an animal, the processor 110 may extract at least one of the type (e.g., dog or cat) of the animal, fur color, fur pattern, and texture. According to an embodiment, when the category of the tracked object is a thing, the processor 110 may extract at least one of the type of the thing, the color of the thing, the texture, the outline, and a saliency map.

According to an embodiment, the zoom information obtained by the processor 110 may include at least one of the width of a first camera preview, the height thereof, the coordinates of the object, the size of the object, the coordinates of the first region of interest, information on the position of the object in the first region of interest, and an area of the object in the first region of interest.

According to an embodiment, the processor 110 may store the obtained tracking information and zoom information in the memory 140.

According to an embodiment, the processor 110 may, in operation 520, activate the second camera 122. According to an embodiment, the processor 110 may activate the second camera 122 before switching from the first camera 121 to the second camera 122, and track the object in the background by using the activated second camera 122.

According to an embodiment, the processor 110 may, in operation 530, transmit the tracking information and zoom information. According to an embodiment, the processor 110 may transmit (or transfer) the tracking information and zoom information stored in the memory 140 to the second camera 122. According to an embodiment, the tracking information and zoom information may be transferred to the second camera 122 through a camera system path or a framework path.

According to an embodiment, the processor 110 may, in operation 540, track an object by using the second camera 122. According to an embodiment, the processor 110 may track the same object as the object tracked via the first camera 121 by using the second camera 122, based on the tracking information and zoom information received by the second camera 122.

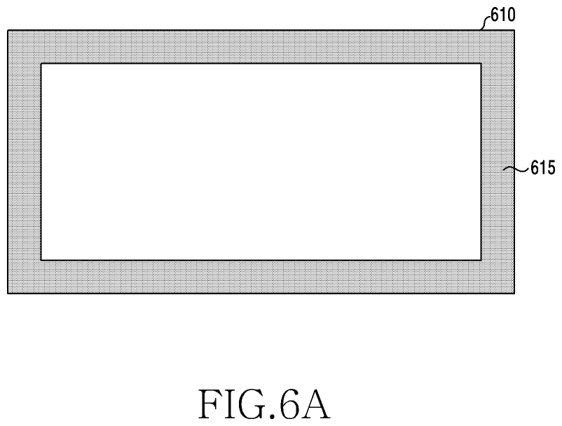

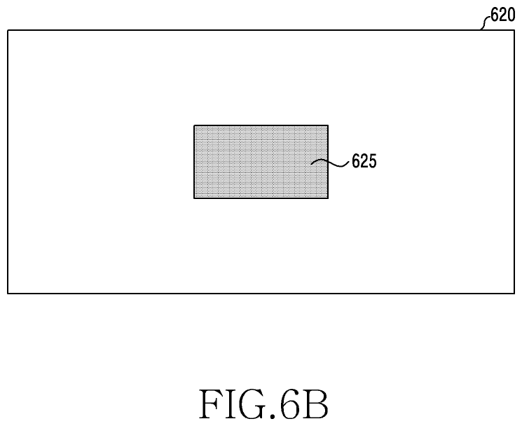

FIG. 6A illustrates a conversion region at a first field of view of a first camera when the first field of view is smaller than a second field of view of a second camera in an electronic device according to an embodiment of the disclosure.

Referring to FIG. 6A, when the first field of view is smaller than the second field of view, the processor 110 may determine a conversion region 615 to be a region adjacent to the border of a first field of view 610. For example, the processor 110 may determine, as the conversion region 615, a region within a range of about 10% from the border of the first field of view 610. However, the conversion region 615 being a region within about 10% from the border of the first field of view 610 merely corresponds to an example, and the conversion region 615 may be variously defined within about 10%-90% from the border of the first field of view 610.

FIG. 6B illustrates a conversion region at a first field of view when the field of view of a first camera is greater than that of a second camera in an electronic device according to an embodiment of the disclosure.

Referring to FIG. 6B, when the first field of view is greater than the second field of view, the processor 110 may determine a conversion region 625 to be a region on which a preview of the first camera and a preview of the second camera overlap with each other. For example, the processor 110 may determine, as the conversion region 625, a region within a range of about 10% from the center of the first field of view 620. However, the conversion region 625 being a region within about 10% from the center of the first field of view 620 merely corresponds to an example, and the conversion region 625 may be variously defined within about 10%-90% from the center of the first field of view 620.

According to an embodiment, the processor 110 may perform various determination according to a movement speed of a tracked object, calibration data, or a configuration value.

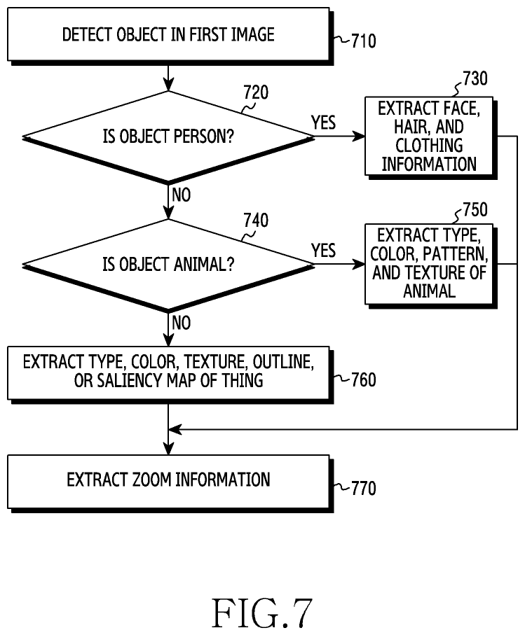

FIG. 7 is a flowchart of an operation of obtaining category information on an object tracked via a first camera in an electronic device according to an embodiment of the disclosure. A description for FIG. 7 overlapping with or corresponding to the above description will be briefly given or omitted.

Referring to FIG. 7, the processor 110 according to an embodiment may, in operation 710, detect an object in a first image. According to an embodiment, the processor 110 may automatically detect at least one object in a preview of the first image. According to another embodiment, the processor 110 may detect at least one object in response to reception of a user input (e.g., touch input) on the display 130, while the preview of the first image is displayed on the display 130.

According to an embodiment, the processor 110 may, in operation 720, determine whether the object detected in the first image is a person. According to an embodiment, when multiple objects are detected in the first image, the processor 110 may determine whether each of the multiple objects is a person.

According to an embodiment, when the object detected in the first image is determined to be a person, the processor 110 may, in operation 730, extract face, hair, and/or clothing information on the object.

According to an embodiment, when the object detected in the first image is not determined to be a person, the processor 110 may, in operation 740, determine whether the detected object is an animal. According to an embodiment, when multiple objects are detected in the first image, the processor 110 may determine whether each of the multiple objects is an animal.

According to an embodiment, when the object detected in the first image is determined to be an animal, the processor 110 may, in operation 750, extract the type, color, pattern, and/or texture of the object.

According to an embodiment, when the object detected in the first image is not determined to be an animal, the processor 110 may, in operation 760, extract the type, color, texture, outline, or saliency map of the object.

According to an embodiment, the processor 110 may, in operation 770, extract zoom information. According to an embodiment, the processor 110 may obtain zoom information including at least one of the width of a first camera preview, the height thereof, the coordinates of the object, the size of the object, the coordinates of a first region of interest, information on the position of the object in the first region of interest, and an area of the object in the first region of interest.

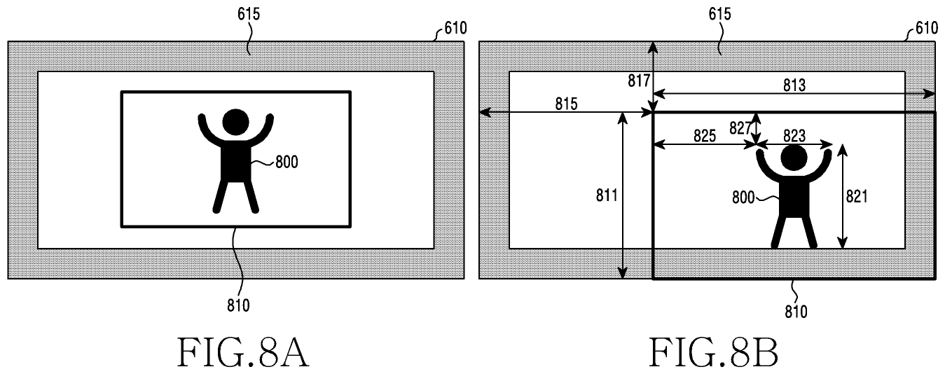

FIGS. 8A and 8B illustrate extracting zoom information according to a movement of an object when the field of view of a first camera is smaller than that of a second camera in an electronic device according to an embodiment of the disclosure.

Referring to FIG. 8A, the processor 110 according to an embodiment may identify an object 800 in the first field of view 610, and determine a first region of interest 810 corresponding to the identified object 800. According to an embodiment, the processor 110 may determine the conversion region 615 in the first field of view 610.

Referring to FIG. 8B, the processor 110 according to an embodiment may change the first region of interest 810 according to a movement of the identified object 800. According to an embodiment, the processor 110 may determine the first region of interest 810, based on the coordinates of the identified object 800.

According to an embodiment, the processor 110 may obtain zoom information according to determination of the first region of interest 810. According to an embodiment, the processor 110 may obtain zoom information including a size of the first region of interest 810 and a position of the first region of interest 810 in a preview. For example, the size of the first region of interest 810 may be determined by a height 811 of the first region of interest and a width 813 of the first region of interest. In addition, for example, the position of the first region of interest in the preview may be determined by coordinates 815 and 817 of the first region of interest.

According to an embodiment, the processor 110 may obtain zoom information including a position of the object 800 in the first region of interest 810 and a ratio of the size of the object 800 to the first region of interest 810. For example, a ratio of the size of the object 800 to the first region of interest 810 may be determined based on a height 821 of the object 800 and a width 823 of the object 800. In addition, for example, the position of the object 800 in the first region of interest 810 may be determined by coordinates 825 and 827 of the object.

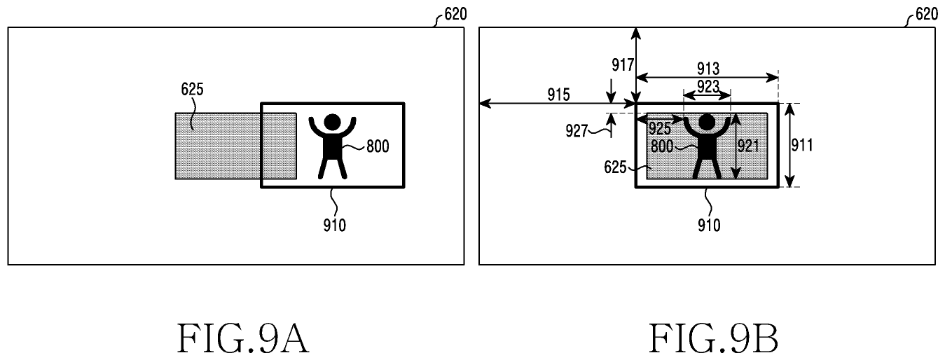

FIGS. 9A and 9B illustrate extracting zoom information according to a movement of an object when the field of view of a first camera is greater than that of a second camera in an electronic device according to an embodiment of the disclosure.

Referring to FIG. 9A, the processor 110 according to an embodiment may identify an object 800 in the first field of view 620, and determine a first region of interest 910 corresponding to the identified object 800. According to an embodiment, the processor 110 may determine the conversion region 625 in the first field of view 620.

Referring to FIG. 9B, the processor 110 according to an embodiment may change the first region of interest 910 according to a movement of the identified object 800. According to an embodiment, the processor 110 may determine the first region of interest 910, based on the coordinates of the identified object 800.

According to an embodiment, the processor 110 may obtain zoom information according to determination of the first region of interest 910. According to an embodiment, the processor 110 may obtain zoom information including a size of the first region of interest 910 and a position of the first region of interest 910 in a preview. For example, the size of the first region of interest 910 may be determined by a height 911 of the first region of interest and a width 913 of the first region of interest. In addition, for example, the position of the first region of interest in the preview may be determined by coordinates 915 and 917 of the first region of interest.

According to an embodiment, the processor 110 may obtain zoom information including a position of the object 800 in the first region of interest 910 and a ratio of the size of the object 800 to the first region of interest 910. For example, a ratio of the size of the object 800 to the first region of interest 910 may be determined based on a height 921 of the object 800 and a width 923 of the object 800. In addition, for example, the position of the object 800 in the first region of interest 910 may be determined by coordinates 925 and 927 of the object.

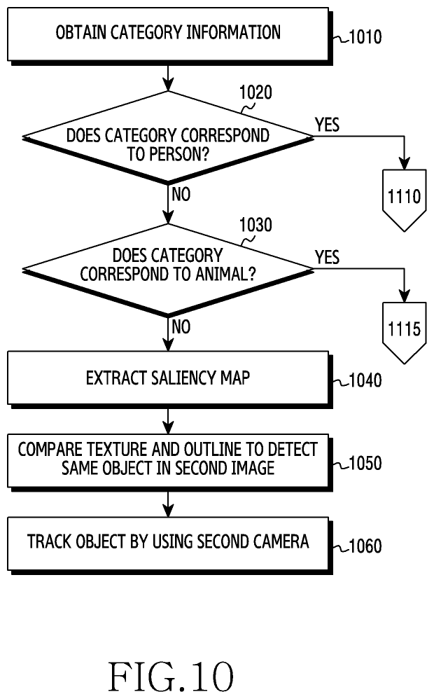

FIG. 10 is a flowchart illustrating a case of tracking, based on category information on an object tracked by an electronic device, the same object via a second camera (e.g., the second camera 122 in FIG. 1) according to an embodiment of the disclosure.

Referring to FIG. 10, the processor 110 according to an embodiment may, in operation 1010, obtain category information on a tracked object. According to an embodiment, the processor 110 may obtain category information on a tracked object, based on tracking information obtained by the second camera 122 from the memory 140.

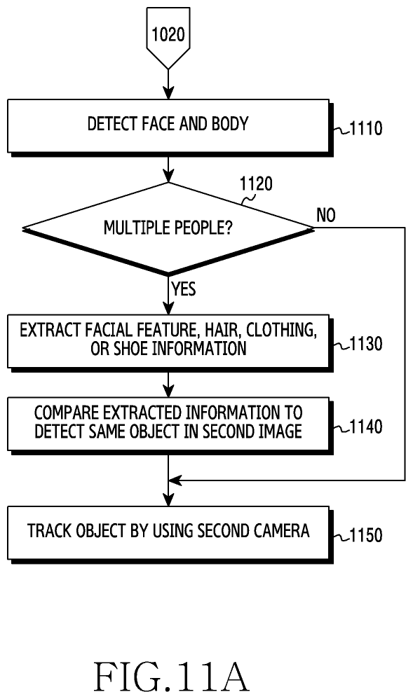

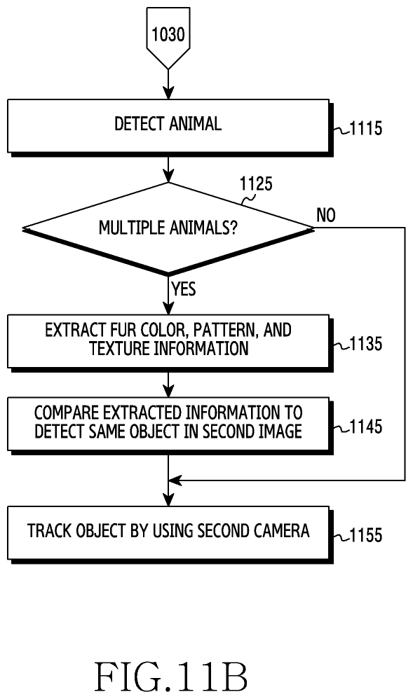

According to an embodiment, the processor 110 may, in operation 1020, determine whether the category of the tracked object corresponds to a person. According to an embodiment, when the category of the tracked object is determined to correspond to a person, the processor 110 may detect the face and body of the object in a preview of the second camera. This will be described with reference to FIG. 11A.

According to an embodiment, when the category of the tracked object is not determined to correspond to a person, the processor 110 may, in operation 1030, determine whether the category of the tracked object corresponds to an animal. According to an embodiment, when the category of the tracked object is determined to correspond to an animal, the processor 110 may detect an animal in the preview of the second camera. This will be described with reference to FIG. 11B.

According to an embodiment, when the category of the tracked object is not determined to correspond to an animal, the processor 110 may, in operation 1040, extract a saliency map from the preview of the second camera 122.

According to an embodiment, the processor 110 may, in operation 1050, compare a texture and an outline with those of the tracked object so as to detect the same object as the tracked object in the preview of the second camera 122. According to an embodiment, the processor 110 may compare a texture and an outline with those of the tracked object, based on the saliency map extracted from the preview of the second camera 122 so as to detect the same object as the tracked object.

According to an embodiment, the processor 110 may, in operation 1060, track the detected object by using the second camera. According to an embodiment, the processor 110 may track the same object as the object tracked via the first camera 121 by using the second camera 122, based on category information obtained from the memory 140.

FIG. 11A is a flowchart illustrating a case of, when an object tracked by an electronic device (e.g., the electronic device 100 in FIG. 1) is a person, tracking the same object via a second camera (e.g., the second camera 122 in FIG. 1) according to an embodiment of the disclosure.

Referring to FIG. 11A, when the category of the tracked object is determined to correspond to a person in operation 1020 of FIG. 10, the processor 110 may, in operation 1110, detect a face and/or a body in a preview of the second camera 122.

According to an embodiment, the processor 110 may, in operation 1120, determine whether multiple people are included in the preview of the second camera 122. According to an embodiment, based on detection of a face and/or a body in the preview of the second camera 122, the processor 110 may determine whether multiple people are included in the preview of the second camera 122.

According to an embodiment, when it is not determined that multiple people are included in the preview of the second camera, the processor 110 may, in operation 1150, track an object (e.g., a person) identified in the preview of the second camera by using the second camera. According to an embodiment, when the number of people included in the preview of the second camera 122 is determined to be one, the processor 110 may track the one person by using the second camera 122.

According to an embodiment, when it is determined that multiple people are included in the preview of the second camera 122, the processor 110 may, in operation 1130, extract a facial feature (e.g., the eyes, the nose, the mouth, the eyebrows, and a facial outer line), hair, or clothing shoe information on each of the multiple people.

According to an embodiment, the processor 110 may, in operation 1140, compare the extracted information to detect the same object in a second image. According to an embodiment, the processor 110 may compare tracking information and zoom information obtained from the memory 140 with information extracted from the preview of the second camera 122 so as to determine, in the second image, the same object as the object tracked via the first camera 121.

According to an embodiment, the processor 110 may, in operation 1150, track an object by using the second camera 122. According to an embodiment, the processor 110 may track the object determined as the same object in operation 1140.

FIG. 11B is a flowchart illustrating a case of, when an object tracked by an electronic device is an animal, tracking the same object via a second camera according to an embodiment of the disclosure.

Referring to FIG. 11B, when the category of the tracked object is determined to correspond to an animal in operation 1030 of FIG. 10, the processor 110 may, in operation 1115, detect an animal in a preview of the second camera 122.

According to an embodiment, the processor 110 may, in operation 1125, determine whether multiple animals are included in the preview of the second camera. According to an embodiment, based on detection of an animal in the preview of the second camera 122, the processor 110 may determine whether multiple animals are included in the preview of the second camera 122.

According to an embodiment, when it is not determined that multiple animals are included in the preview of the second camera 122, the processor 110 may, in operation 1155, track an object (e.g., an animal) identified in the preview of the second camera 122 by using the second camera 122. According to an embodiment, when the number of animals included in the preview of the second camera 122 is determined to be one, the processor 110 may track the one animal by using the second camera 122.

According to an embodiment, when it is determined that multiple animals are included in the preview of the second camera 122, the processor 110 may, in operation 1135, extract information on a fur color, a pattern, and a texture of each of the multiple animals.

According to an embodiment, the processor 110 may, in operation 1145, compare the extracted information to detect the same object in a second image. According to an embodiment, the processor 110 may compare tracking information and zoom information obtained from the memory 140 with information extracted from the preview of the second camera 122 so as to determine, in the second image, the same object as the object tracked via the first camera 121.

According to an embodiment, the processor 110 may, in operation 1155, track the object, which has been determined as the same object in operation 1145, by using the second camera. According to an embodiment, the processor 110 may track the object determined as the same object in operation 1140.

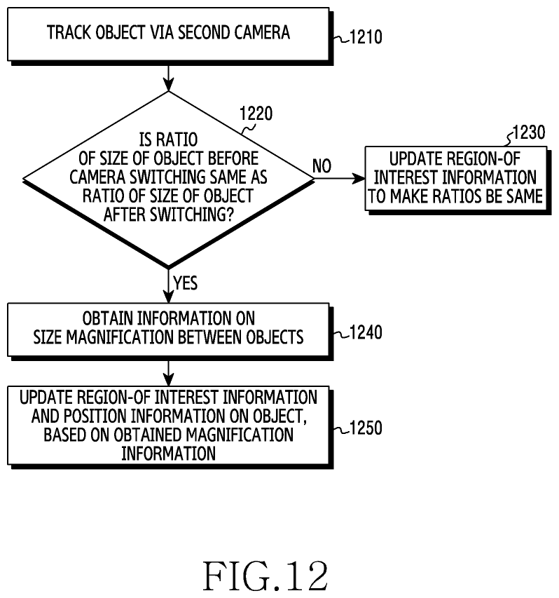

FIG. 12 is a flowchart illustrating recalculating a zoom region in an electronic device according to an embodiment of the disclosure.

Referring to FIG. 12, according to an embodiment, the processor 110 may, in operation 1210, track an object via a second camera (e.g., the second camera 122 in FIG. 1). According to an embodiment, the processor 110 may track the same object as an object tracked via a first camera (e.g., the first camera 121 in FIG. 1) by using the second camera 122. According to an embodiment, the processor 110 may detect and track, in a preview of the second camera 122, the same object as the object tracked via the first camera 121, based on tracking information and zoom information stored in the memory 140.

According to an embodiment, the processor 110 may, in operation 1220, determine whether a ratio of the size of the object before camera switching is the same as a ratio of the size of the object after switching. According to an embodiment, the processor 110 may determine, based on zoom information stored in the memory 140, whether a ratio of the size of the object to a region of interest in a preview of the first camera 121 is the same as a ratio of the size of the object to a region of interest in the preview of the second camera 122. In this document, the region of interest in the preview of the first camera 121 may be referred to as a first region of interest, and the region of interest in the preview of the second camera 122 may be referred to as a second region of interest.

According to an embodiment, when the ratio of the size of the object before camera switching is determined not to be the same as the ratio of the size of the object after switching, the processor 110 may, in operation 1230, update region-of-interest information to make the ratios be the same. According to an embodiment, when the ratio of the size of the object to the first region of interest is determined not to be the same as the ratio of the size of the object to the second region of interest, the processor 110 may update region-of-interest information so that the ratio of the size of the object to the first region of interest is the same as the ratio of the size of the object to the second region of interest. For example, the region-of-interest information may include at least one of size information and position information on a region of interest. For example, the processor 110 may re-calculate (or determine) the size and/or the position of the second region of interest so that the ratio of the size of the object to the second region of interest is the same as the ratio of the size of the object to the first region of interest.

According to an embodiment, when the ratio of the size of the object before camera switching is determined to be the same as the ratio of the size of the object after switching, the processor 110 may, in operation 1240, obtain information on size magnification between objects. According to an embodiment, when the ratio of the size of the object to the first region of interest is determined to be the same as the ratio of the size of the object to the second region of interest, the processor 110 may obtain information on size magnification between an object identified in a first image and an object identified in a second image.

According to an embodiment, the processor 110 may, in operation 1250, update the region-of-interest information and position information on an object, based on the obtained magnification information. According to an embodiment, the processor 110 may update the region-of-interest information and position information on an object, based on the information on size magnification between the object identified in the first image and the object identified in the second image. For example, the position information on the object may include information on the coordinates of the object in a region of interest. According to an embodiment, the processor 110 may update information on the size and/or the position of a region of interest, and the position of an object in the region of interest, based on the information on size magnification between the object identified in the first image and the object identified in the second image. According to an embodiment, the processor 110 may determine the second region of interest, based on the updated region-of-interest information and position information on the object.

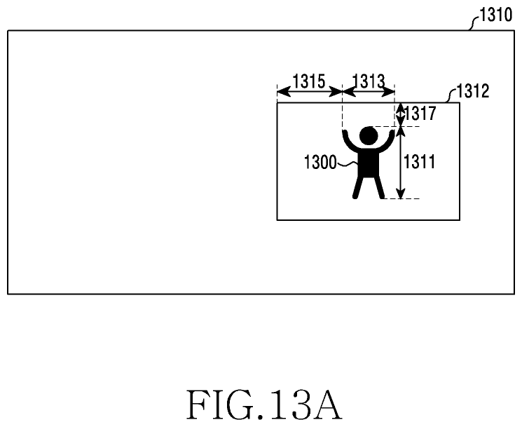

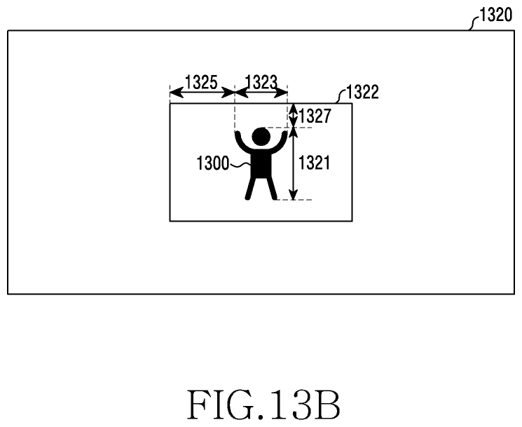

FIG. 13A illustrates a second region of interest being determined when the field of view of a first camera is smaller than that of a second camera in an electronic device (e.g., the electronic device 100 in FIG. 1) according to an embodiment of the disclosure. Contents, among the description related to FIG. 13A, overlapping with or corresponding to the above contents will be briefly given or omitted.

Referring to FIG. 13A, the processor 110 according to an embodiment may determine a second region of interest 1312 in a second field of view 1310. According to an embodiment, the processor 110 may determine the second region of interest 1312 in the second field of view 1310, based on tracking information and zoom information stored in the memory 140.

According to an embodiment, the processor 110 may determine a size of the second region of interest 1312 so that a ratio of a size of an object 1300 to the second region of interest 1312 is the same as a ratio of a size of an object (e.g., the object 800 in FIG. 8) to a first region of interest (e.g., the first region of interest 810 in FIG. 8). For example, the ratio of the size of the object 1300 to the second region of interest 1312 may be determined based on a height 1311 of the object 1300 and a width 1313 of the object 1300.

According to an embodiment, the processor 110 may determine a position of the second region of interest 1312 so that a position of the object 1300 in the second region of interest 1312 is the same as the position of the object 800 in the first region of interest 810. For example, the position of the object 1300 in the second region of interest 1312 may be determined by coordinates 1315 and 1317 of the object. The object 800 included in the first region of interest 810 and the object 1300 included in the second region of interest 1312 are the same.

FIG. 13B illustrates a second region of interest being determined when the field of view of a first camera is greater than that of a second camera in an electronic device according to an embodiment of the disclosure. Contents, among the description related to FIG. 13B, overlapping with or corresponding to the above contents will be briefly given or omitted.

Referring to FIG. 13B, the processor 110 according to an embodiment may determine a second region of interest 1322 in a second field of view 1320. According to an embodiment, the processor 110 may determine the second region of interest 1322 in the second field of view 1320, based on tracking information and zoom information stored in the memory 140.

According to an embodiment, the processor 110 may determine a size of the second region of interest 1322 so that a ratio of a size of an object 1300 to the second region of interest 1322 is the same as a ratio of a size of an object (e.g., the object 800 in FIG. 9) to a first region of interest (e.g., the first region of interest 910 in FIG. 9). For example, the ratio of the size of the object 1300 to the second region of interest 1322 may be determined based on a height 1321 of the object 1300 and a width 1323 of the object 1300.

According to an embodiment, the processor 110 may determine a position of the second region of interest 1322 so that a position of the object 1300 in the second region of interest 1322 is the same as the position of the object 800 in the first region of interest 910. For example, the position of the object 1300 in the second region of interest 1322 may be determined by coordinates 1325 and 1327 of the object. The object 800 included in the first region of interest 910 and the object 1300 included in the second region of interest 1322 are the same.

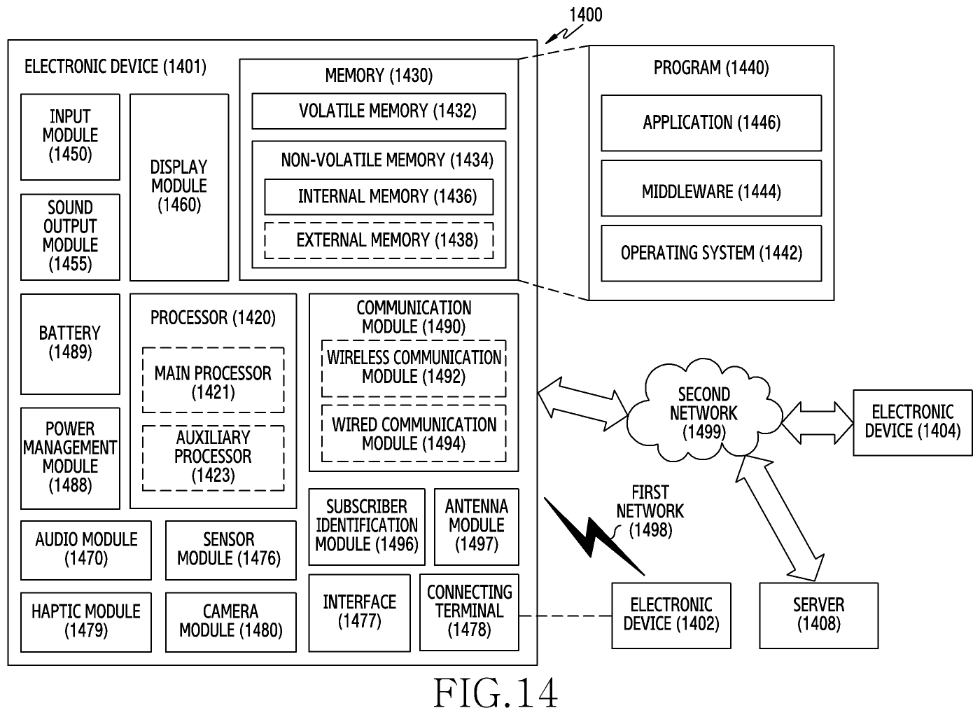

FIG. 14 is a block diagram of an electronic device in a network environment according to an embodiment of the disclosure.

Referring to FIG. 14, the electronic device 1401 in the network environment 1400 may communicate with an electronic device 1402 via a first network 1498 (e.g., a short-range wireless communication network), or at least one of an electronic device 1404 or a server 1408 via a second network 1499 (e.g., a long-range wireless communication network). According to an embodiment, the electronic device 1401 may communicate with the electronic device 1404 via the server 1408. According to an embodiment, the electronic device 1401 may include a processor 1420, memory 1430, an input module 1450, a sound output module 1455, a display module 1460, an audio module 1470, a sensor module 1476, an interface 1477, a connecting terminal 1478, a haptic module 1479, a camera module 1480, a power management module 1488, a battery 1489, a communication module 1490, a subscriber identification module (SIM) 1496, or an antenna module 1497. In some embodiments, at least one of the components (e.g., the connecting terminal 1478) may be omitted from the electronic device 1401, or one or more other components may be added in the electronic device 1401. In some embodiments, some of the components (e.g., the sensor module 1476, the camera module 1480, or the antenna module 1497) may be implemented as a single component (e.g., the display module 1460).

The processor 1420 may execute, for example, software (e.g., a program 1440) to control at least one other component (e.g., a hardware or software component) of the electronic device 1401 coupled with the processor 1420, and may perform various data processing or computation. According to one embodiment, as at least part of the data processing or computation, the processor 1420 may store a command or data received from another component (e.g., the sensor module 1476 or the communication module 1490) in volatile memory 1432, process the command or the data stored in the volatile memory 1432, and store resulting data in non-volatile memory 1434. According to an embodiment, the processor 1420 may include a main processor 1421 (e.g., a central processing unit (CPU) or an application processor (AP)), or an auxiliary processor 1423 (e.g., a graphics processing unit (GPU), a neural processing unit (NPU), an image signal processor (ISP), a sensor hub processor, or a communication processor (CP)) that is operable independently from, or in conjunction with, the main processor 1421. For example, when the electronic device 1401 includes the main processor 1421 and the auxiliary processor 1423, the auxiliary processor 1423 may be adapted to consume less power than the main processor 1421, or to be specific to a specified function. The auxiliary processor 1423 may be implemented as separate from, or as part of the main processor 1421.

The auxiliary processor 1423 may control at least some of functions or states related to at least one component (e.g., the display module 1460, the sensor module 1476, or the communication module 1490) among the components of the electronic device 1401, instead of the main processor 1421 while the main processor 1421 is in an inactive (e.g., sleep) state, or together with the main processor 1421 while the main processor 1421 is in an active state (e.g., executing an application). According to an embodiment, the auxiliary processor 1423 (e.g., an image signal processor or a communication processor) may be implemented as part of another component (e.g., the camera module 1480 or the communication module 1490) functionally related to the auxiliary processor 1423. According to an embodiment, the auxiliary processor 1423 (e.g., the neural processing unit) may include a hardware structure specified for artificial intelligence model processing. An artificial intelligence model may be generated by machine learning. Such learning may be performed, e.g., by the electronic device 1401 where the artificial intelligence is performed or via a separate server (e.g., the server 1408). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1430 may store various data used by at least one component (e.g., the processor 1420 or the sensor module 1476) of the electronic device 1401. The various data may include, for example, software (e.g., the program 1440) and input data or output data for a command related thereto. The memory 1430 may include the volatile memory 1432 or the non-volatile memory 1434.

The program 1440 may be stored in the memory 1430 as software, and may include, for example, an operating system (OS) 1442, middleware 1444, or an application 1446.

The input module 1450 may receive a command or data to be used by another component (e.g., the processor 1420) of the electronic device 1401, from the outside (e.g., a user) of the electronic device 1401. The input module 1450 may include, for example, a microphone, a mouse, a keyboard, a key (e.g., a button), or a digital pen (e.g., a stylus pen).

The sound output module 1455 may output sound signals to the outside of the electronic device 1401. The sound output module 1455 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1460 may visually provide information to the outside (e.g., a user) of the electronic device 1401. The display module 1460 may include, for example, a display, a hologram device, or a projector and control circuitry to control a corresponding one of the display, hologram device, and projector. According to an embodiment, the display module 1460 may include a touch sensor adapted to detect a touch, or a pressure sensor adapted to measure the intensity of force incurred by the touch.

The audio module 1470 may convert a sound into an electrical signal and vice versa. According to an embodiment, the audio module 1470 may obtain the sound via the input module 1450, or output the sound via the sound output module 1455 or a headphone of an external electronic device (e.g., an electronic device 1402) directly (e.g., wiredly) or wirelessly coupled with the electronic device 1401.

The sensor module 1476 may detect an operational state (e.g., power or temperature) of the electronic device 1401 or an environmental state (e.g., a state of a user) external to the electronic device 1401, and then generate an electrical signal or data value corresponding to the detected state. According to an embodiment, the sensor module 1476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1477 may support one or more specified protocols to be used for the electronic device 1401 to be coupled with the external electronic device (e.g., the electronic device 1402) directly (e.g., wiredly) or wirelessly. According to an embodiment, the interface 1477 may include, for example, a high definition multimedia interface (HDMI), a universal serial bus (USB) interface, a secure digital (SD) card interface, or an audio interface.

A connecting terminal 1478 may include a connector via which the electronic device 1401 may be physically connected with the external electronic device (e.g., the electronic device 1402). According to an embodiment, the connecting terminal 1478 may include, for example, a HDMI connector, a USB connector, a SD card connector, or an audio connector (e.g., a headphone connector).

The haptic module 1479 may convert an electrical signal into a mechanical stimulus (e.g., a vibration or a movement) or electrical stimulus which may be recognized by a user via his tactile sensation or kinesthetic sensation. According to an embodiment, the haptic module 1479 may include, for example, a motor, a piezoelectric element, or an electric stimulator.

The camera module 1480 may capture a still image or moving images. According to an embodiment, the camera module 1480 may include one or more lenses, image sensors, image signal processors, or flashes.

The power management module 1488 may manage power supplied to the electronic device 1401. According to one embodiment, the power management module 1488 may be implemented as at least part of, for example, a power management integrated circuit (PMIC).

The battery 1489 may supply power to at least one component of the electronic device 1401. According to an embodiment, the battery 1489 may include, for example, a primary cell which is not rechargeable, a secondary cell which is rechargeable, or a fuel cell.

The communication module 1490 may support establishing a direct (e.g., wired) communication channel or a wireless communication channel between the electronic device 1401 and the external electronic device (e.g., the electronic device 1402, the electronic device 1404, or the server 1408) and performing communication via the established communication channel. The communication module 1490 may include one or more communication processors that are operable independently from the processor 1420 (e.g., the application processor (AP)) and supports a direct (e.g., wired) communication or a wireless communication. According to an embodiment, the communication module 1490 may include a wireless communication module 1492 (e.g., a cellular communication module, a short-range wireless communication module, or a global navigation satellite system (GNSS) communication module) or a wired communication module 1494 (e.g., a local area network (LAN) communication module or a power line communication (PLC) module). A corresponding one of these communication modules may communicate with the external electronic device via the first network 1498 (e.g., a short-range communication network, such as Bluetooth™, wireless-fidelity (Wi-Fi) direct, or infrared data association (IrDA)) or the second network 1499 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1492 may identify and authenticate the electronic device 1401 in a communication network, such as the first network 1498 or the second network 1499, using subscriber information (e.g., international mobile subscriber identity (IMSI)) stored in the subscriber identification module 1496.

The wireless communication module 1492 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1492 may support a high-frequency band (e.g., the mmWave band) to achieve, e.g., a high data transmission rate. The wireless communication module 1492 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1492 may support various requirements specified in the electronic device 1401, an external electronic device (e.g., the electronic device 1404), or a network system (e.g., the second network 1499). According to an embodiment, the wireless communication module 1492 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1497 may transmit or receive a signal or power to or from the outside (e.g., the external electronic device) of the electronic device 1401. According to an embodiment, the antenna module 1497 may include an antenna including a radiating element composed of a conductive material or a conductive pattern formed in or on a substrate (e.g., a printed circuit board (PCB)). According to an embodiment, the antenna module 1497 may include a plurality of antennas (e.g., array antennas). In such a case, at least one antenna appropriate for a communication scheme used in the communication network, such as the first network 1498 or the second network 1499, may be selected, for example, by the communication module 1490 (e.g., the wireless communication module 1492) from the plurality of antennas. The signal or the power may then be transmitted or received between the communication module 1490 and the external electronic device via the selected at least one antenna. According to an embodiment, another component (e.g., a radio frequency integrated circuit (RFIC)) other than the radiating element may be additionally formed as part of the antenna module 1497.

According to various embodiments, the antenna module 1497 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1401 and the external electronic device 1404 via the server 1408 coupled with the second network 1499. Each of the electronic devices 1402 or 1404 may be a device of a same type as, or a different type, from the electronic device 1401. According to an embodiment, all or some of operations to be executed at the electronic device 1401 may be executed at one or more of the external electronic devices 1402, 1404, or 1408. For example, if the electronic device 1401 should perform a function or a service automatically, or in response to a request from a user or another device, the electronic device 1401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1401. The electronic device 1401 may provide the outcome, with or without further processing of the outcome, as at least part of a reply to the request. To that end, a cloud computing, distributed computing, mobile edge computing (MEC), or client-server computing technology may be used, for example. The electronic device 1401 may provide ultra low-latency services using, e.g., distributed computing or mobile edge computing. In another embodiment, the external electronic device 1404 may include an internet-of-things (IoT) device. The server 1408 may be an intelligent server using machine learning and/or a neural network. According to an embodiment, the external electronic device 1404 or the server 1408 may be included in the second network 1499. The electronic device 1401 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1440) including one or more instructions that are stored in a storage medium (e.g., internal memory 1436 or external memory 1438) that is readable by a machine (e.g., the electronic device 1401). For example, a processor (e.g., the processor 1420) of the machine (e.g., the electronic device 1401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

FIG. 15 is a block diagram showing an example of a camera module according to an embodiment of the disclosure.

Referring to FIG. 15, the camera module 1480 may include a lens assembly 1510, a flash 1520, an image sensor 1530, an image stabilizer 1540, memory 1550 (e.g., buffer memory), or an image signal processor 1560. The lens assembly 1510 may collect light emitted or reflected from an object whose image is to be taken. The lens assembly 1510 may include one or more lenses. According to an embodiment, the camera module 1480 may include a plurality of lens assemblies 1510. In such a case, the camera module 1480 may form, for example, a dual camera, a 360-degree camera, or a spherical camera. Some of the plurality of lens assemblies 1510 may have the same lens attribute (e.g., view angle, focal length, auto-focusing, f number, or optical zoom), or at least one lens assembly may have one or more lens attributes different from those of another lens assembly. The lens assembly 1510 may include, for example, a wide-angle lens or a telephoto lens.

The flash 1520 may emit light that is used to reinforce light reflected from an object. According to an embodiment, the flash 1520 may include one or more light emitting diodes (LEDs) (e.g., a red-green-blue (RGB) LED, a white LED, an infrared (IR) LED, or an ultraviolet (UV) LED) or a xenon lamp. The image sensor 1530 may obtain an image corresponding to an object by converting light emitted or reflected from the object and transmitted via the lens assembly 1510 into an electrical signal. According to an embodiment, the image sensor 1530 may include one selected from image sensors having different attributes, such as an RGB sensor, a black-and-white (BW) sensor, an IR sensor, or a UV sensor, a plurality of image sensors having the same attribute, or a plurality of image sensors having different attributes. Each image sensor included in the image sensor 1530 may be implemented using, for example, a charged coupled device (CCD) sensor or a complementary metal oxide semiconductor (CMOS) sensor.

The image stabilizer 1540 may move the image sensor 1530 or at least one lens included in the lens assembly 1510 in a particular direction, or control an operational attribute (e.g., adjust the read-out timing) of the image sensor 1530 in response to the movement of the camera module 1480 or the electronic device 1401 including the camera module 1480. This allows compensating for at least part of a negative effect (e.g., image blurring) by the movement on an image being captured. According to an embodiment, the image stabilizer 1540 may sense such a movement by the camera module 1480 or the electronic device 1401 using a gyro sensor (not shown) or an acceleration sensor (not shown) disposed inside or outside the camera module 1480. According to an embodiment, the image stabilizer 1540 may be implemented, for example, as an optical image stabilizer. The memory 1550 may store, at least temporarily, at least part of an image obtained via the image sensor 1530 for a subsequent image processing task. For example, if image capturing is delayed due to shutter lag or multiple images are quickly captured, a raw image obtained (e.g., a Bayer-patterned image, a high-resolution image) may be stored in the memory 1550, and its corresponding copy image (e.g., a low-resolution image) may be previewed via the display module 1460. Thereafter, if a specified condition is met (e.g., by a user's input or system command), at least part of the raw image stored in the memory 1550 may be obtained and processed, for example, by the image signal processor 1560. According to an embodiment, the memory 1550 may be configured as at least part of the memory 1430 or as a separate memory that is operated independently from the memory 1430.

The image signal processor 1560 may perform one or more image processing with respect to an image obtained via the image sensor 1530 or an image stored in the memory 1550. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 1560 may perform control (e.g., exposure time control or read-out timing control) with respect to at least one (e.g., the image sensor 1530) of the components included in the camera module 1480. An image processed by the image signal processor 1560 may be stored back in the memory 1550 for further processing, or may be provided to an external component (e.g., the memory 1430, the display module 1460, the electronic device 1402, the electronic device 1404, or the server 1408) outside the camera module 1480. According to an embodiment, the image signal processor 1560 may be configured as at least part of the processor 1420, or as a separate processor that is operated independently from the processor 1420. If the image signal processor 1560 is configured as a separate processor from the processor 1420, at least one image processed by the image signal processor 1560 may be displayed, by the processor 1420, via the display module 1460 as it is or after being further processed.

According to an embodiment, the electronic device 1401 may include a plurality of camera modules 1480 having different attributes or functions. In such a case, at least one of the plurality of camera modules 1480 may form, for example, a wide-angle camera and at least another of the plurality of camera modules 1480 may form a telephoto camera. Similarly, at least one of the plurality of camera modules 1480 may form, for example, a front camera and at least another of the plurality of camera modules 1480 may form a rear camera.

As described above, an electronic device (e.g., the electronic device in FIG. 1) according to an embodiment may include multiple cameras (e.g., the camera 120 in FIG. 1), a display (e.g., the display 130 in FIG. 1), and at least one processor (e.g., the processor 110 in FIG. 1) configured to execute an application supporting image capturing using the multiple cameras, obtain a first image having a first field of view via a first camera among the multiple cameras, display a preview using the first image on the display in a state where a magnification for the image capturing is configured to be a first magnification, change the preview using the first image, displayed on the display, to include at least one object identified in the first image according to a movement of the at least one object, change the magnification for the image capturing to a second magnification, based on the at least one object being positioned in a designated region of the first field of view, obtain a second image having a second field of view via a second camera among the multiple cameras, the second magnification being determined based on the first field of view, the second field of view, and a position of the at least one object in the first field of view, and display at least a part of the second image on the display as the preview, in a state in which the magnification for the image capturing is configured to be the second magnification.

According to an embodiment, the at least one processor 110 may be further configured to switch from the obtaining of the first image via the first camera to the obtaining of the second image via the second camera, based on a determination that the at least one object is positioned in the designated region of the first field of view for a designated time or longer.

According to an embodiment, the at least one processor 110 may be further configured to activate the second camera before the switch from the obtaining of the first image via the first camera to obtain the first image to using the second camera to obtain the second image, and track the at least one object via the activated second camera.

According to an embodiment, the at least one processor 110 may be further configured to, after the switch from the obtaining of the second image via the first camera to the obtaining of the second image via the second camera, display, on the display as the preview, the at least the part of the second image, in which a blur effect is applied to at least a partial region among a region remaining after excluding the at least one object.

According to an embodiment, the at least one processor 110 may be further configured to obtain category information on the at least one object identified in the first image, detect the at least one object by using the second camera, based on the obtained category information, and track the detected at least one object by using the second camera.

According to an embodiment, the electronic device 110 may further include a memory (e.g., the memory 140 in FIG. 1), wherein the at least one processor 110 is further configured to determine a first region of interest including the at least one object, and store, in the memory, first information including information on a position of the at least one object in the first region of interest, and a ratio of a size of the at least one object to the first region of interest.

According to an embodiment, the at least one processor 110 may be further configured to determine the first region of interest, based on coordinates of the at least one object.

According to an embodiment, the at least one processor 110 may be further configured to update the first information according to a change in the position of the at least one object in the first region of interest, or the ratio of the size of the at least one object to the first region of interest.

According to an embodiment, the at least one processor 110 may be further configured to determine a second region of interest including the at least one object, based on the first information stored in the memory, wherein the position of the at least one object in the first region of interest, and the ratio of the size of the at least one object to the first region of interest correspond to a position of the at least one object in the second region of interest, and a ratio of a size of the at least one object to the second region of interest, and deactivate the first camera based on the second region of interest being determined.

According to an embodiment, the at least one processor 110 may be further configured to determine a size of the designated region of the first field of view, based on a movement speed of the at least one object identified in the first image.

According to an embodiment, in a case in which the first field of view is smaller than the second field of view, the at least one processor 110 may be further configured to determine, as the designated region of the first field of view, a region adjacent to a border of the first field of view.

According to an embodiment, in a case in which the first field of view is greater than the second field of view, the at least one processor 110 may be further configured to determine, as the designated region of the first field of view, a region overlapping with or smaller than the second field of view.

According to an embodiment, each of the first camera and the second camera may be one of a tele camera, a wide camera, or an ultra-wide camera.

As described above, a method performed by an electronic device (e.g., the electronic device 100 in FIG. 1) according to an embodiment may include executing an application supporting image capturing using multiple cameras (e.g., the camera 120 in FIG. 1), obtaining a first image having a first field of view via a first camera among the multiple cameras, displaying a preview using the first image on a display (e.g., the display 130 in FIG. 1) in a state where a magnification for the image capturing is configured to be a first magnification, changing the preview using the first image, displayed on the display, to include at least one object identified in the first image according to a movement of the at least one object, changing the magnification for the image capturing to a second magnification, based on the at least one object being positioned in a designated region of the first field of view, obtaining a second image having a second field of view via a second camera among the multiple cameras, the second magnification being determined based on the first field of view, the second field of view, and a position of the at least one object in the first field of view, and displaying at least a part of the second image on the display as the preview, in a state in which the magnification for the image capturing is configured to be the second magnification.

According to an embodiment, the method may include switching from the obtaining of the first image via the first camera to the obtaining of the second image via the second camera, based on a determination that the at least one object is positioned in the designated region of the first field of view for a designated time or longer.

According to an embodiment, the method may include activating the second camera before the switching from the obtaining of the first image via the first camera to the obtaining of the second image via the second camera, and tracking an object identical to the at least one object via the activated second camera.

According to an embodiment, the displaying of the at least the part of the second image on the display as the preview may include applying a blur effect to at least a partial region, among a region remaining after excluding the at least one object, after he switching from the obtaining of the first image via the first camera to the obtaining of the second image via the second camera, and displaying the preview.

According to an embodiment, the method may further include obtaining category information on the at least one object identified in the first image, detecting the at least one object by using the second camera, based on the obtained category information, and tracking the detected at least one object by using the second camera.

According to an embodiment, the method may include determining a first region of interest including the at least one object, and storing, in a memory, first information including information on a position of the at least one object in the first region of interest, and a ratio of a size of the at least one object to the first region of interest.

According to an embodiment, the method may include determining a second region of interest including the at least one object, based on the first information stored in the memory, wherein the position of the at least one object in the first region of interest, and the ratio of the size of the at least one object to the first region of interest correspond to a position of the at least one object in the second region of interest, and a ratio of a size of the at least one object to the second region of interest, and deactivating the first camera based on the second region of interest being determined.

According to an embodiment, the method may include determining the first region of interest, based on coordinates of the at least one object.

According to an embodiment, the method may include updating the first information according to a change in the position of the at least one object in the first region of interest, or the ratio of the size of the at least one object to the first region of interest.

According to an embodiment, each of the first camera and the second camera may be one of a tele camera, a wide camera, or an ultra-wide camera.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
multiple cameras;
a display; and
at least one processor configured to:
execute an application supporting image capturing using the multiple cameras,
obtain a first image having a first field of view via a first camera among the multiple cameras,
display a preview using the first image on the display in a state where a magnification for the image capturing is configured to be a first magnification,
change the preview using the first image, displayed on the display, to include at least one object identified in the first image according to a movement of the at least one object,
change the magnification for the image capturing to a second magnification, based on to the at least one object being positioned in a designated region of the first field of view,
obtain a second image having a second field of view via a second camera among the multiple cameras, the second magnification being determined based on the first field of view, the second field of view, and a position of the at least one object in the first field of view, and
display at least a part of the second image on the display as the preview, in a state in which the magnification for the image capturing is configured to be the second magnification.

2. The electronic device of claim 1, wherein the at least one processor is further configured to switch from the obtaining of the first image via the first camera to the obtaining of the second image via the second camera, based on a determination that the at least one object is positioned in the designated region of the first field of view for a designated time or longer.

3. The electronic device of claim 2, wherein the at least one processor is further configured to:
activate the second camera before the switch from the obtaining of the first image via the first camera to the obtaining of the second image via the second camera, and
track the at least one object via the activated second camera.

4. The electronic device of claim 2, wherein the at least one processor is further configured to, after the switch from the obtaining of the first image via the first camera to the obtaining of the second image via the second camera, display, on the display as the preview, the at least the part of the second image, in which a blur effect is applied to at least a partial region among a region remaining after excluding the at least one object.

5. The electronic device of claim 1, wherein the at least one processor is further configured to:
obtain category information on the at least one object identified in the first image,
detect the at least one object by using the second camera, based on the obtained category information, and
track the detected at least one object by using the second camera.

6. The electronic device of claim 1, further comprising:
a memory,
wherein the at least one processor is further configured to:
determine a first region of interest including the at least one object, and
store, in the memory, first information including information on a position of the at least one object in the first region of interest, and a ratio of a size of the at least one object to the first region of interest.

7. The electronic device of claim 6, wherein the at least one processor is further configured to determine the first region of interest, based on coordinates of the at least one object.

8. The electronic device of claim 6, wherein the at least one processor is further configured to update the first information according to a change in the position of the at least one object in the first region of interest, or the ratio of the size of the at least one object to the first region of interest.

9. The electronic device of claim 6, wherein the at least one processor is further configured to:
determine a second region of interest including the at least one object, based on the first information stored in the memory, wherein the position of the at least one object in the first region of interest, and the ratio of the size of the at least one object to the first region of interest correspond to a position of the at least one object in the second region of interest, and a ratio of a size of the at least one object to the second region of interest, and
deactivate the first camera based on the second region of interest being determined.

10. The electronic device of claim 1, wherein the at least one processor is further configured to determine a size of the designated region of the first field of view, based on a movement speed of the at least one object identified in the first image.

11. The electronic device of claim 1, wherein, in a case in which the first field of view is smaller than the second field of view, the at least one processor is further configured to determine, as the designated region of the first field of view, a region adjacent to a border of the first field of view.

12. The electronic device of claim 1, wherein, in a case in which the first field of view is greater than the second field of view, the at least one processor is further configured to determine, as the designated region of the first field of view, a region overlapping with or smaller than the second field of view.

13. The electronic device of claim 1, wherein each of the first camera and the second camera is one of a tele camera, a wide camera, or an ultra-wide camera.

14. A method performed by an electronic device, the method comprising:
executing an application supporting image capturing using multiple cameras;
obtaining a first image having a first field of view via a first camera among the multiple cameras;
displaying a preview using the first image on a display in a state where a magnification for the image capturing is configured to be a first magnification;
changing the preview using the first image, displayed on the display, to include at least one object identified in the first image according to a movement of the at least one object;
changing the magnification for the image capturing to a second magnification, based on the at least one object being positioned in a designated region of the first field of view;
obtaining a second image having a second field of view via a second camera among the multiple cameras, the second magnification being determined based on the first field of view, the second field of view, and a position of the at least one object in the first field of view; and
displaying at least a part of the second image on the display as the preview, in a state in which the magnification for the image capturing is configured to be the second magnification.

15. The method of claim 14, further comprising switching from the obtaining of the first image via the first camera to the obtaining of the second image via the second camera, based on a determination that the at least one object is positioned in the designated region of the first field of view for a designated time or longer.

16. The method of claim 15, further comprising:
activating the second camera before the switching from the obtaining of the first image via the first camera to the obtaining of the second image via the second camera; and
tracking an object identical to the at least one object via the activated second camera.

17. The method of claim 15, wherein the displaying of the at least the part of the second image on the display as the preview comprises:
applying a blur effect to at least a partial region, among a region remaining after excluding the at least one object, after the switching from the obtaining of the first image via the first camera to the obtaining of the second image via the second camera; and
displaying the preview.

18. The method of claim 14, further comprising:
obtaining category information on the at least one object identified in the first image;
detecting the at least one object by using the second camera, based on the obtained category information; and
tracking the detected at least one object by using the second camera.

19. The method of claim 14, further comprising:
determining a first region of interest including the at least one object; and
storing, in a memory, first information including information on a position of the at least one object in the first region of interest, and a ratio of a size of the at least one object to the first region of interest.

20. The method of claim 19, further comprising:
determining a second region of interest including the at least one object, based on the first information stored in the memory, wherein the position of the at least one object in the first region of interest, and the ratio of the size of the at least one object to the first region of interest correspond to a position of the at least one object in the second region of interest, and a ratio of a size of the at least one object to the second region of interest; and
deactivating the first camera based on the second region of interest being determined.
